(19) United States
(12) Patent Application Publication
(10) Pub. No.: US 2009/0047489 A1
(43) Pub. Date: Feb. 19, 2009

(54) Composite article having adjustable surface morphology and methods of making and using

(75) Inventors: David S. Grummon, E. Lansing, MI (US); Yang T. Cheng, Troy, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/839,720

(22) Filed: Aug. 16, 2007

(51) Int. Cl. B32B 7/02; B29C 43/02; B05D 1/38; B05D 5/00

(52) U.S. Cl. 428/212; 428/542.8; 427/419.1; 427/428.01; 264/319

(57) ABSTRACT

Disclosed are composite articles having adjustable surface morphologies, methods of making the composite articles, and methods of using the composite articles. The composite articles generally include an active layer comprising a shape memory material configured to undergo a change in property upon receipt of an activation signal, a bias layer configured to provide a mechanism for the composite article to return to a first shape from a second shape, and an activation device for providing the activation signal to the shape memory material.

### BACKGROUND

The present disclosure generally relates to composite articles having adjustable surface morphologies, wherein the surface morphology can be configured to control frictional force levels at an interface between a surface of the composite material and another surface.

Several devices or processes rely on the creation or elimination of a frictional force between opposing, contacting surfaces of two bodies to perform a specific function or operation. Exemplary devices having surfaces configured to produce or eliminate a frictional force include clutches, brakes (drum brakes, disc brakes, and the like), bearings, traction drives, devices that control fluid over or between surfaces, tires, mechanical seals, clamps, and the like. Many of these devices are either unable to control the frictional force level, or control the frictional force level by adjusting the speed of, or normal force exerted by, at least one of the contacting surfaces.

Existing devices utilize actuators and motors to change relative speeds of and/or normal forces exerted by at least one of the contacting surfaces. For example, brake actuators can change a normal force between brake pads to change frictional force levels. However, current devices for changing frictional force levels can be expensive due to the high costs of separate actuators or motors. Further, other operational or functional requirements may not permit actuators and motors to be utilized to control frictional force levels.

Accordingly, there remains a need for improved devices and methods for controlling the frictional force at the interface of two contacting bodies.

### BRIEF SUMMARY

Disclosed herein is a composite article including an active layer comprising a shape memory material configured to undergo a change in property upon receipt of an activation signal, a bias layer configured to provide a mechanism for the composite article to return to a first shape from a second shape, and an activation device for providing the activation signal to the shape memory material.

Also disclosed is a method for making the composite article having the adjustable surface morphology. The method includes forming a recessed portion in an active layer comprising a shape memory material configured to undergo a change in a property upon receipt of an activation signal, and forming a bias layer over at least a portion of the recessed portion of the active layer, wherein forming the recessed portion and forming the bias layer are accomplished absent the activation signal.

Further disclosed herein is a method for using the composite article having the adjustable surface morphology. The method includes activating a shape memory material of an active layer of the composite article with an activation device and changing a shape of a surface of the composite article from a first shape to a second shape, wherein the surface of the composite article comprises a bias layer deposited thereon to restore the shape of the surface of the composite article to the first shape.

The above described and other features are exemplified by the following figures and detailed description.

### BRIEF DESCRIPTION OF THE DRAWINGS

Referring now to the figures, which are exemplary embodiments and wherein the like elements are numbered alike:

FIG. 1 is a schematic representation of a process for making a composite article having an adjustable surface morphology;

FIG. 2 is a schematic representation of the composite article of FIG. 1 in first and second configurations;

FIG. 3 is a schematic representation of (a) a process for adding a friction producing element to the composite article of FIG. 1, and (b) the friction producing element's orientation when the composite article is in the first and second configurations; and

FIG. 4 is a schematic representation of (a) a process for adding a friction producing element to the composite article of FIG. 1, and (b) the friction producing element's orientation when the composite article is in the first and second configurations, in accordance with another embodiment.

### DETAILED DESCRIPTION

Disclosed herein are articles having adjustable surface morphologies, as well as methods for making and using these devices. The articles generally comprise an active layer and a bias layer, wherein the active layer comprises a shape memory material configured to exhibit a change in a fundamental property such as stiffness and/or dimension when subjected to an applied field (e.g., heat), and wherein the bias layer provides a return mechanism for the article to return to a specific shape after the applied field is removed. Advantageously, by varying the surface morphology of the article, a frictional force between the article and another body to which the article is contacted can be controlled.

As used herein, the term “shape memory material” refers to materials that exhibit a shape memory effect. Specifically, after being deformed pseudo-plastically, they can be restored to their original shape by the application of the appropriate field. In this manner, shape memory materials can change to a determined shape in response to an activation signal. It is these properties that advantageously will allow for adjustable tribological properties of the articles disclosed herein. Suitable shape memory materials include, without limitation, shape memory alloys (SMA), ferromagnetic shape memory alloys (FSMA), shape memory polymers (SMP), and composites comprising at least one of the foregoing shape memory materials. Of the different shape memory materials, SMPs and FSMAs are most desirable for applications requiring a high number of shape changing cycles and/or high frictional force levels.

By way of background, shape memory alloys are capable of undergoing phase transitions in which their yield strength, stiffness, dimension and/or shape are altered as a function of temperature. The most commonly utilized of these temperature-dependent phases are the so-called martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (As). The temperature at which this phenomenon is complete is called the austenite finish temperature (Af). When the shape memory alloy is in the austenite phase and is cooled, it begins to change into the martensite phase, and the temperature at which this phenomenon starts is referred to as the martensite start temperature (Ms). The temperature at which austenite finishes transforming to martensite is called the martensite finish temperature (Mf). Generally, shape memory alloys are softer and more easily deformable in their martensitic phase and are harder, stiffer, and/or more rigid in the austenitic phase.

In view of the foregoing properties, deformation of the shape memory alloy is preferably at or below the austenite transition temperature (at or below As). Subsequent heating above the austenite transition temperature causes the deformed shape memory alloy to revert back to its permanent shape. Thus, a suitable activation signal for use with shape memory alloys is a thermal activation signal having a magnitude to cause transformations between the martensite and austenite phases. SMAs exhibit a modulus increase of about 2.5 times and a dimensional change of up to about 8% (depending on the amount of pre-strain) when heated above its martensite to austenite phase transition temperature.

The temperature at which the shape memory alloy remembers its high temperature form when heated can be adjusted by slight changes in the composition of the alloy and through heat treatment. In nickel-titanium shape memory alloys, for instance, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing shape memory effects, superelastic effects, and high damping capacity.

Suitable shape memory alloy materials include, but are not intended to be limited to, nickel-titanium alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. The alloys can be binary, ternary, or any higher order so long as the alloy composition exhibits a shape memory effect, (e.g., a change in shape orientation, changes in yield strength, and/or flexural modulus properties, damping capacity, superelasticity, and the like). Selection of a suitable shape memory alloy composition depends on the temperature range where the component will operate, and can be done without undue experimentation by one skilled in the art in view of this disclosure.

In contrast to SMAs, ferromagnetic SMAs exhibit rapid dimensional changes of up to several percent in response to (and proportional to the strength of) an applied magnetic field. Accordingly, a component of the FSMA must exhibit ferromagnetic behavior.

“Shape memory polymer” generally refers to a polymeric material, which exhibits a change in a property, such as an elastic modulus, a shape, a dimension, a shape orientation, or a combination comprising at least one of the foregoing properties upon application of an activation signal. Shape memory polymers may be thermoresponsive (i.e., the change in the property is caused by a thermal activation signal), photoresponsive (i.e., the change in the property is caused by a light-based activation signal), moisture-responsive (i.e., the change in the property is caused by a liquid activation signal such as humidity, water vapor, or water), or a combination comprising at least one of the foregoing.

Generally, SMPs are phase segregated co-polymers comprising at least two different units, which may be described as defining different segments within the SMP, each segment contributing differently to the overall properties of the SMP. As used herein, the term “segment” refers to a block, graft, or sequence of the same or similar monomer or oligomer units, which are copolymerized to form the SMP. Each segment may be crystalline or amorphous and will have a corresponding melting point or glass transition temperature (Tg), respectively. The term “thermal transition temperature” is used herein for convenience to generically refer to either a Tg or a melting point depending on whether the segment is an amorphous segment or a crystalline segment. For SMPs comprising (n) segments, the SMP is said to have a hard segment and (n-1) soft segments, wherein the hard segment has a higher thermal transition temperature than any soft segment. Thus, the SMP has (n) thermal transition temperatures. The thermal transition temperature of the hard segment is termed the “last transition temperature”, and the lowest thermal transition temperature of the so-called “softest” segment is termed the “first transition temperature”. It is important to note that if the SMP has multiple segments characterized by the same thermal transition temperature, which is also the last transition temperature, then the SMP is said to have multiple hard segments.

When the SMP is heated above the last transition temperature, the SMP material can be imparted a permanent shape. A permanent shape for the SMP can be set or memorized by subsequently cooling the SMP below that temperature. As used herein, the terms “original shape”, “previously defined shape”, and “permanent shape”, when referring to SMPs, are synonymous and are intended to be used interchangeably. A temporary shape can be set by heating the material to a temperature higher than a thermal transition temperature of any soft segment yet below the last transition temperature, applying an external stress or load to deform the SMP, and then cooling below the particular thermal transition temperature of the soft segment while maintaining the deforming external stress or load.

The permanent shape can be recovered by heating the material, with the stress or load removed, above the particular thermal transition temperature of the soft segment yet below the last transition temperature. Thus, it should be clear that by combining multiple soft segments it is possible to demonstrate multiple temporary shapes and with multiple hard segments it may be possible to demonstrate multiple permanent shapes. Similarly using a layered or composite approach, a combination of multiple SMPs will demonstrate transitions between multiple temporary and permanent shapes.

For SMPs with only two segments, the temporary shape of the shape memory polymer is set at the first transition temperature, followed by cooling of the SMP, while under load, to lock in the temporary shape. The temporary shape is maintained as long as the SMP remains below the first transition temperature. The permanent shape is regained when the SMP is once again brought above the first transition temperature with the load removed. Repeating the heating, shaping, and cooling steps can repeatedly reset the temporary shape.

Most SMPs exhibit a “one-way” effect, wherein the SMP exhibits one permanent shape. Upon heating the shape memory polymer above a soft segment thermal transition temperature without a stress or load, the permanent shape is achieved and the shape will not revert back to the temporary shape without the use of outside forces.

As an alternative, some shape memory polymer compositions can be prepared to exhibit a “two-way” effect, wherein the SMP exhibits two permanent shapes. These systems include at least two polymer components. For example, one component could be a first cross-linked polymer while the other component is a different cross-linked polymer. The components are combined by layer techniques, or are interpenetrating networks, wherein the two polymer components are cross-linked but not to each other. By changing the temperature, the shape memory polymer changes its shape in the direction of a first permanent shape or a second permanent shape. Each of the permanent shapes belongs to one component of the SMP. The temperature dependence of the overall shape is caused by the fact that the mechanical properties of one component (“component A”) are almost independent of the temperature in the temperature interval of interest. The mechanical properties of the other component (“component B”) are temperature dependent in the temperature interval of interest. In one embodiment, component B becomes stronger at low temperatures compared to component A, while component A is stronger at high temperatures and determines the actual shape. A two-way memory device can be prepared by setting the permanent shape of component A (“first permanent shape”), deforming the device into the permanent shape of component B (“second permanent shape”), and fixing the permanent shape of component B while applying a stress.

It should be recognized by one of ordinary skill in the art that it is possible to configure SMPs in many different forms and shapes. Engineering the composition and structure of the polymer itself can allow for the choice of a particular temperature for a desired application. For example, depending on the particular application, the last transition temperature may be about 0° C. to about 300° C. or above. A temperature for shape recovery (i.e., a soft segment thermal transition temperature) may be greater than or equal to about —30° C. Another temperature for shape recovery may be greater than or equal to about 40° C. Another temperature for shape recovery may be greater than or equal to about 100° C. Another temperature for shape recovery may be less than or equal to about 250° C. Yet another temperature for shape recovery may be less than or equal to about 200° C. Finally, another temperature for shape recovery may be less than or equal to about 150° C.

Optionally, the SMP can be selected to provide stress-induced yielding, which may be used directly (i.e. without heating the SMP above its thermal transition temperature to ‘soften’ it) to make the pad conform to a given surface. The maximum strain that the SMP can withstand in this case can, in some embodiments, be comparable to the case when the SMP is deformed above its thermal transition temperature.

Although reference has been, and will further be, made to thermoresponsive SMPs, those skilled in the art in view of this disclosure will recognize that photoresponsive, moisture-responsive SMPs and SMPs activated by other methods may readily be used in addition to or substituted in place of thermoresponsive SMPs. For example, instead of using heat, a temporary shape may be set in a photoresponsive SMP by irradiating the photoresponsive SMP with light of a specific wavelength (while under load) effective to form specific crosslinks and then discontinuing the irradiation while still under load. To return to the original shape, the photoresponsive SMP may be irradiated with light of the same or a different specific wavelength (with the load removed) effective to cleave the specific crosslinks. Similarly, a temporary shape can be set in a moisture-responsive SMP by exposing specific functional groups or moieties to moisture (e.g., humidity, water, water vapor, or the like) effective to absorb a specific amount of moisture, applying a load or stress to the moisture-responsive SMP, and then removing the specific amount of moisture while still under load. To return to the original shape, the moisture-responsive SMP may be exposed to moisture (with the load removed).

Suitable shape memory polymers, regardless of the particular type of SMP, can be thermoplastics, thermosets-thermoplastic copolymers, interpenetrating networks, semi-interpenetrating networks, or mixed networks. The SMP “units” or “segments” can be a single polymer or a blend of polymers. The polymers can be linear or branched elastomers with side chains or dendritic structural elements. Suitable polymer components to form a shape memory polymer include, but are not limited to, polyphosphazenes, poly(vinyl alcohols), polyamides, polyimides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), poly(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecylacrylate). Examples of other suitable polymers include polystyrene, polypropylene, polyvinyl phenol, polyvinylpyrrolidone, chlorinated polybutylene, poly(octadecyl vinyl ether), poly (ethylene vinyl acetate), polyethylene, poly(ethylene oxide)-poly(ethylene terephthalate), polyethylenelnylon (graft copolymer), polycaprolactones-polyamide (block copolymer), poly(caprolactone) diniethacrylate-n-butyl acrylate, poly(norbornyl-polyhedral oligomeric silsequioxane), polyvinylchloride, urethane/butadiene copolymers, polyurethane-containing block copolymers, styrene-butadiene block copolymers, and the like. The polymer(s) used to form the various segments in the SMPs described above are either commercially available or can be synthesized using routine chemistry. Those of skill in the art can readily prepare the polymers using known chemistry and processing techniques without undue experimentation.

The shape memory materials may be heated by any suitable means. For example, for elevated temperatures, heat may be supplied using hot gas (e.g., air), steam, hot liquid, or electrical current. The activation means may, for example, be in the form of heat conduction from a heated element/fluid in contact with the shape memory material, heat convection from a heated conduit in proximity to the shape memory material, a hot air blower, microwave interaction, laser heating, flash lamp heating, infrared heating, resistive heating, thermoelectric heating, and the like. In the case of a temperature drop, heat may be extracted by using cold gas, cold fluid, evaporation of a refrigerant, thermoelectric cooling, or by simply removing the heat source for a time sufficient to allow the shape memory material to cool down via thermodynamic heat transfer. The activation means may, for example, be in the form of a cool room or enclosure, a cooling probe having a cooled tip, a control signal to a thermoelectric unit, a cold air blower, or means for introducing a refrigerant (such as liquid nitrogen) to at least the vicinity of the shape memory material.

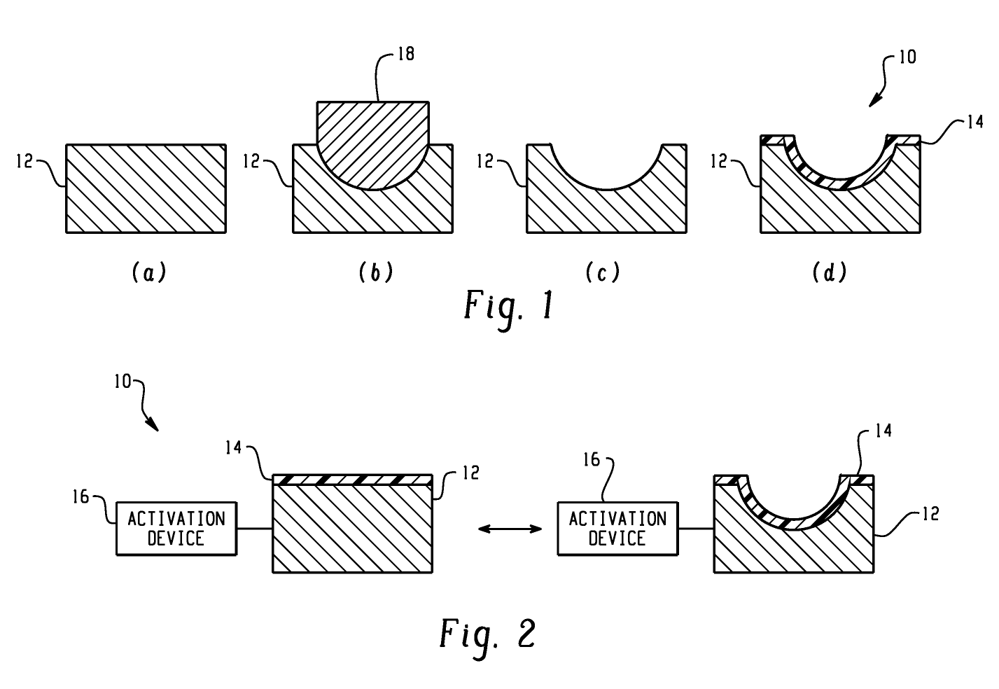

Referring now to FIG. 1 (a) through (d), an exemplary method of making a composite article having an adjustable surface morphology, generally designated 10, is shown. Although reference will be made to a shape memory alloy, it should be recognized that any of the shape memory materials described above can be used. The composite article 10 is processed such that it has a first, “trained” shape as well as a second, “permanent” shape. The “trained” shape, or the shape to which the composite article 10 returns when the temperature of the active layer 12 is above Af, is substantially flat. The trained shape can be taught to the composite article 10 when the shape memory alloy of the active layer 12 is below Mf.

An active layer 12 is shown in FIG. 1 (a) in the permanent shape. The shape memory material of the active layer 12 may be in the form of a solid, a foam, a non-foam solid with cavities or holes either molded or machined therein, a lattice structure, a hollow bladder structure, or the like. A so-called “indenter” 18 is brought into contact with, and used to form a (i.e., at least one) recessed portion on the surface of, the active layer 12 as shown in FIG. 1 (b). In an exemplary embodiment, recessed portions are formed in the active layer by a die having a pattern containing multiple hemispherical-shaped projections or asperities that are configured to indent the active layer 12. During operation, the die supplies a selected pressure to the active layer 12 imprint the recessed portions in the active layer 12. In another embodiment, compression rollers can be utilized to form recessed portions. The compression roller can have a pattern containing hemispherical-shaped projections deposited thereon, or the compression roller can be configured to force active layer 12 on a die containing hemispherical-shaped projections. In another embodiment, a ballistic device can be utilized to form the recessed portion in active layer 12. For example, a ballistic device can shoot ball bearings at the active layer 12 and the ball bearings can form the recessed portions in the active layer 12. The ballistic device can form recessed portions having a predetermined or a random pattern in the active layer 12. In yet another embodiment, a mask can be deposited on the surface of active layer 12, and a regular pattern in the surface of the active layer 12 can be made by shooting the ball bearings through the openings in the mask.

During the indenting step, care must be taken to ensure that the temperature of the shape memory alloy does not increase above As. Once the recessed portion(s) is created, the indenter 18 may be removed from the surface of the active layer 12, as illustrated in FIG. 1 (c). The bias layer can now be produced.

The bias layer, generally designated 14 as seen in FIG. 1 (d), can either be formed within at least the indented or recessed the surface(s) of the active layer 12, or deposited as an over-layer on at least the indented or recessed surface(s) of the active layer 12. The bias layer 14 is provided to restore the composite article 10 to the first, trained shape when the shape memory alloy is cooled to a temperature below Ms, as will be described in more detail below. The bias layer 14 is formed from a highly elastic, high strength material, which has a higher energy (stretched) state and a lower energy (relaxed) state. The bias layer 14 is formed in the lower energy state while maintaining the shape memory alloy in the martensite phase.

In an exemplary embodiment, the bias layer 14 is deposited on active layer 12 by ion beam enhanced deposition. Other exemplary techniques for forming the resilient layer on the active layer 12 can include other sputtering techniques (e.g., high energy sputtering), electron-beam evaporation techniques, chemical vapor deposition techniques, electroplating techniques, electroless plating techniques, plasma spraying techniques, and thermal spraying techniques. The bias layer 14 can comprise a metal, ceramic, a composite, or a combination comprising at least one of the foregoing, such that the bias layer 14 has a greater elastic modulus and strength than the active layer 12.

An exemplary composite article 10 having an adjustable surface morphology is shown in FIG. 2 in the first or adjusted (trained) configuration and the second or permanent configuration. In the first configuration, shown on the right, the active layer 12 is in the martensitic phase and the bias layer is in the lower energy state. When an activation device 16, which is in operative communication with the shape memory alloy the active layer 12, provides an activation signal (e.g., heat) to the SMA, the shape memory alloy begins to transform to the austenite phase at As. The shape memory strains within the active layer 12 also cause the bias layer 14 to undergo a transformation from the lower energy state to the higher energy state. Once the temperature is at or above Af, the active layer has completely returned to the permanent shape, shown on the left hand side of FIG. 2.

The force exerted by the SMA of the active layer 12 can maintain the bias layer 14 in the higher energy state as long as the temperature of the SMA does not drop to or below Ms. When the activation signal is no longer applied to the SMA by activation device 16, and the SMA has cooled to a temperature at or below Ms, the active layer 12 can no longer maintain the bias layer 14 in the higher energy state. The desire of the elastically strained bias layer 14 to transition to the lower energy state provides enough force to initiate a reverse transformation by the composite article 10 from the second or permanent shape (left hand side of FIG. 2) to the first or trained shape (right hand side of FIG. 2).

As described, by controlling the state of SMA of the active layer 12, the composite article 10 can cycle between the first shape and the second shape. Composite article 10 having spherical-shaped recessed portion(s) can transition from the first shape to the second shape, and back to the first shape with less than 1% dimensional distortion (i.e., the major dimensions including average radius, circumference and depth of the recessed portion(s) after the phase transition cycle will substantially conform with the dimensions of recessed portion within plus or minus 1% of the original measured dimension). Further, the recessed portion(s) can maintain its dimensions for a selected number of thermal cycles above Af and below Mf. Specifically, the indentation can maintain its structural dimensional stability of less than 1% distortion for at least 100,000 cycles, and even up to 1,000,000 cycles, or more.

The composite article 10 can be used in an application wherein it contacts a second body (which may optionally be a second composite article as disclosed herein) to generate a frictional force at an interface therebetween. When composite article 10 having a first surface morphology contacts a surface of the second body, a first frictional force level is generated. When composite article 10 having the second surface morphology contacts the surface of the second body, a second frictional force level is generated. Changing the surface morphology of the composite article 10 can alter the coefficient of friction or a normal force between the composite article 10 and the second body.

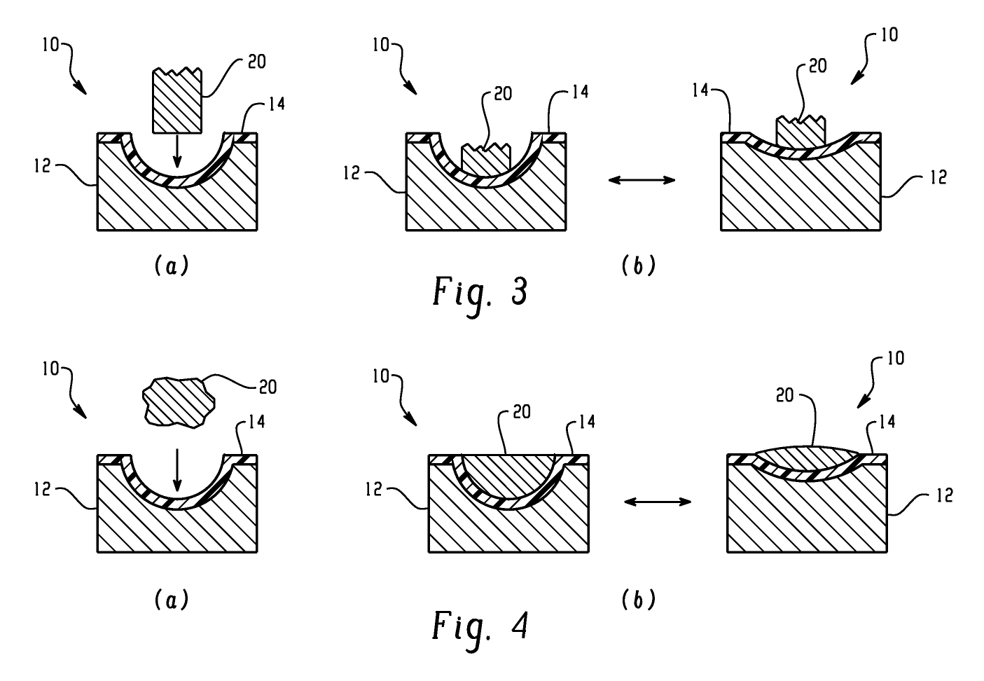

If greater levels of friction are desired between two bodies, a so-called “friction-producing element” can be deposited on the adjustable surface of the composite article 10, as shown in FIGS. 3 (a) and 4 (a). The friction-producing element 20 can comprise various materials to provide specific surface properties to the composite article 10 and/or specific levels of friction between the composite article 10 and the second body. For example, the friction-producing element 20 can comprise elastomeric materials or rubbers to give the friction-producing element 20 a selected compliance level. Further, the friction-producing element 20 can comprise relatively hard materials (e.g., materials having a Mohr's hardness of greater than or equal to about 3.9) to give the friction-producing element 20 abrasive properties. Exemplary hard materials include silica, alumina, aluminum silicate, iron oxide, iron silicate, silicon carbide, boron carbide, diamond, or a combination comprising at least one of the foregoing, and the like.

The friction-producing element 20 can be deposited onto a recessed portion of the composite article 10 by any known deposition technique. For example, if the friction-producing element 20 is a solid particle as illustrated in FIG. 3 (a), it can be physically attached by using an adhesive or vapor-deposited in a specific location (e.g., through a mask having an opening at the selected location). If the friction-producing element 20 is an elastomeric matrix, with or without a bard material deposited therein, as illustrated in FIG. 4 (a), it can be simply be poured into the recessed portion of the composite article 10, and optionally cured or crosslinked. Other techniques make us of adhesive bonds, welds, chemical bonds, physical bonds, and the like.

Operation of the composite article 10 with the friction-producing element 20 deposited thereon as described above for the composite article 10 without the friction-producing element 20. Specifically, as shown in FIGS. 3 (b) and 4 (b), the composite articles 10 can be cycled back and forth between the second shape (shown on the left hand side of each figure) and the first shape (shown on the right hand side of each figure) using the activation device (which has been omitted for clarity).

The adjustable surface of the composite article 10, with or without the friction-producing element 20 deposited thereon, can be optionally exposed to various treatments such as chemical treatments, surface treatments, and the like, so that the surface can have any desired surface features for a particular application.

In addition, the adjustable surface of the composite article 10, with or without the friction-producing element 20 deposited thereon, can optionally have fluid such as a lubricant deposited thereon or therein. The shape transition experienced by the composite article 10 can change a gap distance between the surface of the composite article 10 and the surface of the second body, thereby changing a fluid thickness between the surfaces. By changing the thickness of the lubricant layer, the shape transition can change the rheological dynamics in the lubricant interposed between the surfaces.

In another embodiment, the surface can be configured to generate friction through electrical interactions (e.g., electrochemical interactions, current flow, or electrostatic interactions). For example, the composite article 10 can be configured to receive current flow therethrough, such that static electricity is produced between the surface of the composite article 10 and the surface of the second body upon contact. The amount of static electricity generated and the amount of friction produced by the static electricity can be controlled by the surface morphology of the composite article 10.

It should be recognized that the composite articles 10 described herein can be used in any application that relies on the creation or elimination of a frictional force between opposing, contacting surfaces of two bodies to perform a specific function or operation, such as clutches, brakes (drum brakes, disc brakes, and the like), bearings, traction drives, devices that control fluid over or between surfaces, tires, mechanical seals, clamps, and the like.

It should also be recognized that other devices can be used in conjunction with the composite articles 10 disclosed herein to provide increased control of the frictional force between opposing, contacting surfaces of two bodies. For example, a temperature sensor can be deposited in operative communication with the adjustable surface and the activation device 16 to provide information on the level of heat generated between the contacting bodies. Other such devices would be recognizable to one of skill in the art in view of this disclosure.

While the invention has been described with reference to exemplary embodiments, it will be understood by those skilled in the art that various changes may be made and equivalents may be substituted for elements thereof without departing from the scope of the claims. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

In addition, as used herein, the terms “first”, “second”, and the like do not denote any order or importance, but rather are used to distinguish one element from another, and the terms “the”, “a”, and “an” do not denote a limitation of quantity, but rather denote the presence of at least one of the referenced items. Furthermore, all ranges directed to the same quantity of a given component or measurement are inclusive of the endpoints and independently combinable.

1. A composite article having an adjustable surface morphology, comprising:
an active layer comprising a shape memory material configured to undergo a change in a property upon receipt of an activation signal;
a bias layer configured to provide a mechanism for the composite article to return to a first shape from a second shape; and
an activation device for providing the activation signal to the shape memory material.

2. The composite article of claim 1, wherein the change in the property of the shape memory material is effective to transform the composite article from the first shape to the second shape.

3. The composite article of claim 1, wherein the shape memory material is a shape memory alloy, ferromagnetic shape memory alloy, a shape memory polymer, or a combination comprising at least one of the foregoing shape memory materials.

4. The composite article of claim 1, wherein the bias layer comprises a metal, a ceramic, a composite, or a combination comprising at least one of the foregoing, such that the bias layer has a greater elastic modulus and strength than the active layer.

5. The composite article of claim 1, further comprising a friction-producing element deposited on a shape changing surface of the composite article.

6. The composite article of claim 1, wherein the adjustable surface morphology of the composite article is effective to control a friction force between the composite article and a surface of an other body in contact therewith.

7. The composite article of claim 6, wherein the other body is a second composite article having an adjustable surface morphology.

8. The composite article of claim 1, wherein the composite article comprises at least a portion of a clutch, a brake, a bearing, a traction drive, a mechanical seat, a tire, a device that controls fluid flow over or between surfaces, or a clamp.

9. The composite article of claim 1, wherein the activation signal is a thermal activation signal.

10. A method for making a composite article having an adjustable surface morphology, the method comprising:
forming a recessed portion in an active layer with an indenter, wherein the active layer comprises a shape memory material configured to undergo a change in a property upon receipt of an activation signal; and
forming a bias layer over at least a portion of the recessed portion of the active layer, wherein forming the recessed portion and forming the bias layer are accomplished absent the activation signal.

11. The method of claim 10, further comprising depositing a friction-producing element on at least a portion of a shape-changing surface of the composite article.

12. The method of claim 10, wherein depositing the friction-producing element is accomplished absent the activation signal.

13. The method of claim 10, wherein forming the recessed portion is accomplished by pressing a die onto the active layer, compression rolling the active layer, ballistically contacting the active layer with projectiles, or chemical etching.

14. The method of claim 10, wherein the recessed portion has a substantially hemispherical shape.

15. A method for using a composite article having an adjustable surface morphology, the method comprising:
activating a shape memory material of an active layer of the composite article with an activation device; and
changing a shape of a surface of the composite article from a first shape to a second shape, wherein the surface of the composite article comprises a bias layer deposited thereon to restore the shape of the surface of the composite article to the first shape.

16. The method of claim 15, further comprising restoring the composite article to the first shape from the second shape.

17. The method of claim 16, wherein a measured dimensional distortion between the first shape before the activating and the first shape after the restoring is less than about 1.0%.

18. The method of claim 16, further comprising:
controlling a friction force between the shape-changing surface of the composite article and a surface of an other body in contact therewith by adjusting the shape-changing surface of the composite article from the first or second shape to the other of the first or second shape while maintaining contact between the shape-changing surface of the composite article and the surface of the other body.

19. The method of claim 18, wherein the other body is a second composite article having an adjustable surface morphology.

20. The method of claim 15, wherein the composite article comprises at least a portion of a clutch, a brake, a bearing, a traction drive, a mechanical seal, a tire, a device that controls fluid flow over or between surfaces, or a clamp.
